(19) United States
(12) Patent Application Publication
(10) Pub. No.: US 2015/0310185 A1
(43) Pub. Date: Oct. 29, 2015

(54) IN-HOME IOT MEDICATION DEVICE

(71) Applicant: Ashok Deepak Shah, Atlanta, GA (US)

(72) Inventor: Ashok Deepak Shah, Atlanta, GA (US)

(21) Appl. No.: 14/697,064

(22) Filed: Apr. 27, 2015

Related U.S. Application Data
(60) Provisional application No. 61/985,286, filed on Apr. 28, 2014.

(51) Int. Cl. G06F 19/00; G06K 7/10; A61J 1/18

(52) U.S. Cl. CPC G06F 19/3456; A61J 1/18; G06K 7/10297; A61J 2200/74; A61J 2205/60

(57) ABSTRACT

Technologies for implementing an IOT medication device for use in the home of a patient are described herein. The IOT medication device comprises a controller, at least one near-field communication (“NFC”) transceiver, and one or more displays. The NFC transceiver is operably connected to the controller and configured to read data from an NFC tag attached to a medication container placed in proximity to the transceiver. The controller can then display information related to a medication contained in the medication container on the one or more displays.

### CROSS-REFERENCE TO RELATED APPLICATIONS

This application claims the benefit of U.S. Provisional Application No. 61/985,286, filed Apr. 28, 2014, and entitled “IN-HOME IOT MEDICATION DEVICE,” the entirety of which is hereby incorporated herein by this reference.

### BACKGROUND

As the patient population continues to age, the need for automated mechanisms to check for patient compliance, polypharmacy and preventative medication is becoming more important. Medication compliance continues to remain a major issue when managing patients' adherence to therapy regimens, and modern technology can certainly help. The Internet of Things (“IOT”) provides opportunities to assist patients, doctors, and pharmacies to provide, track, and manage a patient's medications and other health regimens.

It is with respect to these considerations and others that the disclosure made herein is presented.

### BRIEF SUMMARY

The present disclosure relates to technologies for implementing an IOT medication device for use in the home of a patient. According to some embodiments, the IOT medication device comprises a controller, at least one near-field communication (“NFC”) transceiver, and one or more displays. The NFC transceiver is operably connected to the controller and configured to read data from an NFC tag attached to a medication container placed in proximity to the transceiver. The controller can then display information related to a medication contained in the medication container on the one or more displays.

According to further embodiments, a system comprises a database containing an identifier of a medication container and information regarding a medication prescription associated with the medication container, and a cloud service operably connected to the database and exposing an API to the Internet. The system further comprises an IOT medication device connected to the Internet and comprising at least one NFC transceiver and one or more displays. The IOT medication device configured to read data from an NFC tag attached to the medication container when the medication container is placed in proximity to the NFC transceiver. Information regarding the medication prescription is retrieved from the cloud service through the API based on the data read from the NFC tag, and at least a part of the information is displayed to the one or more displays.

According to further embodiments, a method for tagging a medication container with information associated with a prescription and/or medication includes the steps of receiving, at a cloud service, a unique identifier of an NFC tag embedded in the medication container and data associated with the medication container. The data is stored in a database associated with the unique identifier. A request for the data associated with the medication container may later be received at the cloud service, the request containing the unique identifier. The data associated with the medication container is retrieved based on the unique identifier and the data is returned in response to the request.

These and other features and aspects of the various embodiments will become apparent upon reading the following Detailed Description and reviewing the accompanying drawings.

### BRIEF DESCRIPTION OF THE DRAWINGS

FIG. 1 is a diagram showing a perspective view of an illustrative IOT medication device, according to embodiments described herein.

FIG. 2 is a block diagram showing an illustrative hardware architecture for IOT medication devices described in embodiments presented herein.

FIG. 3 is a block diagram showing an illustrative environment for the implementation of an infrastructure supporting managing patients' medication usage, compliance, and regimens, according to embodiments described herein.

FIG. 4 is a flow diagram showing illustrative routines for managing patients' medication usage, compliance, and regimens, according embodiments described herein.

### DETAILED DESCRIPTION

The following detailed description is directed to technologies for managing patients' medication usage, compliance, and regimens. Utilizing the technologies described herein, an IOT medication device may be implemented for use in the home of the patient that creates a feedback loop directly between the pharmacy, patient and physician via the Internet of Things (“IOT”). The device may provide the missing link in the feedback loop between patients, pharmacists, and their various doctors.

As used herein, the Internet of Things refers to a system comprising uniquely identifiable objects and devices and their virtual representations in the cloud. The solution consists of medication containers, such as pill bottles, containing near-field communication (“NFC”) tags, RFID tags, or other electronic identifiers that are encoded with medication information by the pharmacist and made available to the patient via various devices and services. The NFC tagged pill bottles can be reused, recycled, recoded or thrown away. The patient may receive their medication from the pharmacist in the NFC-tagged container and then come home to their NFC-enabled IOT medication device and create preferences (reminders, alerts on medication, alarms, timers, etc.) tied to the medication(s) via their network-connected app/device. The IOT medication device will decode the NFC information and display a picture of the enclosed pill or liquid, its type and unique number/ markings, and the like to the patient.

The IOT medication device may further alert the patient when it is time to take the medication(s) and verify compliance by monitoring change in weight of the medication container or through other measurement means, such as an automated dispenser (not shown in drawings). The IOT medication device may contain Wi-Fi and/or NFC transceivers that allow the device to receive the medication information and sync the information with a cloud-based service. The cloud-based service may further provide polypharmacy checking services, compliance services, and the like to doctors and pharmacists. The polypharmacy checking service may make sure that various specialty physicians (cardiologist vs GI or General Practitioner) are not prescribing duplicate medications or medications that interact with each other. Both the pharmacy and the prescribing physicians can be alerted of possible problems.

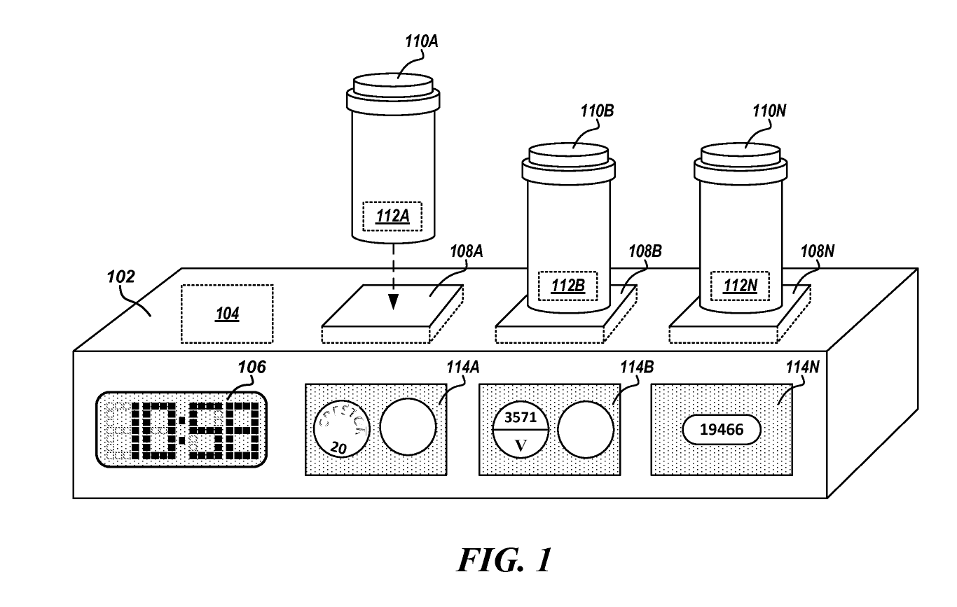

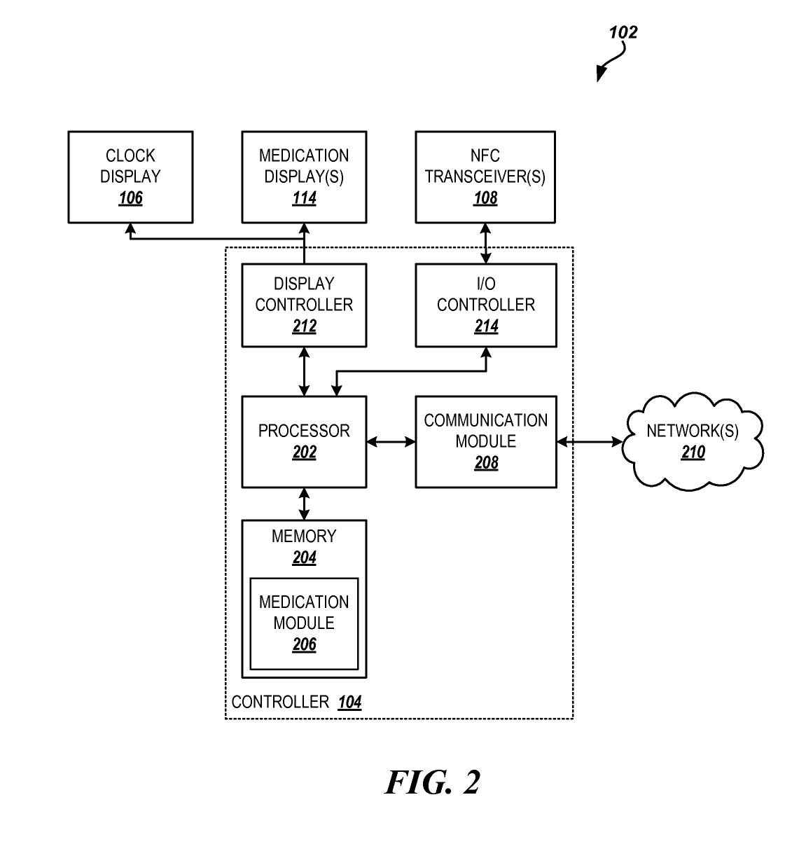

FIG. 1 provides an overview of the components and configuration of an illustrative in-home IOT medication device 102. The device 102 may include a controller 104, which will be described in more detail below in regard to FIG. 2. The IOT medication device 102 may further include a clock display 106, such as a LED/LCD 7-segment display. The clock display 106 may facilitate functions such as current time, alarms, patient reminders for time to take medication, and the like.

The IOT medication device 102 may further include one or more NFC receivers or transceivers, such as NFC transceivers 108A-108N (referred to herein generally as NFC transceiver 108). According to embodiments, the NFC transceivers 108 are configured to read data from and/or write data to NFC tags 112A-112N (referred to herein generally as NFC tags 112) placed or embedded in medication containers 110A-110N (referred to herein generally as medication container 110), such as pill bottles or medicine bottles. The NFC tags 112 may contain data associated with the medication container 110 and/or the medication contained therein, including at least an identifier of the specific medication container. In some embodiments, the data stored in the NFC tags 112 may include an identifier of the medication contained in the medication container 110, an identifier of the patient, an identifier of the prescribing doctor, a quantity of medication contained therein, dosing and timing information for the medication/patient according to the related prescription, an image of the medication with identifying markings, a record of medication taken, and/or the like.

The NFC tags 112 may embedded or placed into the cap of the medication container 110, stuck on the container as an Adapter, or placed inside the container as a “locking plastic enclosure.” This avoids someone removing the NFC tag 112 from the medication container 110, but also allows re-tasking

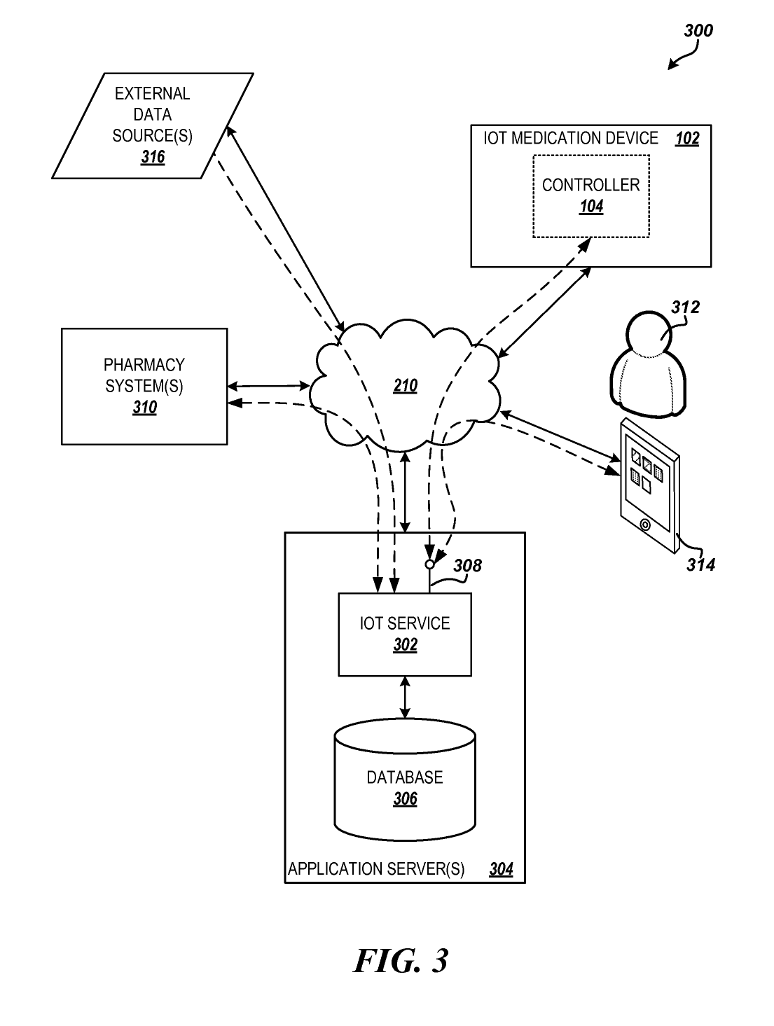

The NFC transceivers 108 may further include a mechanism for checking compliance with a prescription medication contained in the associated medication container 110. For example, the NFC transceivers 108 may include or be incorporated into scales that record the weight of the medication containers 110 placed thereon. The weight of each does (e.g. pill) may be retrieved from the data stored in the NFC tag 112 or retrieve from a cloud-based service (described below in regard to FIG. 3) based on an identifier of the medication or medication container from the NFC tag. Using the weight of each does and the timing of the change in weight of the medication container 110, the IOT medication device 102 may check compliance and alert an associated pharmacist and/or physician that the medication is or isn't being taken. In some embodiments, the IOT medication device 102 may have an incorporated mechanical medication dispenser to count and dispense pills based on the dosage information retrieved from the data stored in the NFC tag 112 or retrieved from the service based on an identifier of the medication or medication container 110 from the NFC tag, as well as check and report compliance.

The IOT medication device 102 may further contain a medication display, such as medication displays 114A-114N (referred to herein generally as medication displays 114), associated with each NFC transceiver 108. The medication displays 114 may be LCD/OLED displays, for example, that show a picture of the medication (with any identifying codes and/or markings) contained in the medication container 110 placed on the associated NFC transceiver 108, an alert and dosing information when the medication is due to be taken, and the like. The image of the medication, dosage and timing information, etc., may be retrieved from the data stored in the NFC tag 112 or retrieved from the cloud-based service based on an identifier of the medication or medication container 110 from the NFC tag.

FIG. 2 provides an illustrative schematic of the IOT medication device 102, including the controller 104. The controller 104 may comprise a processor 202 for executing logic to perform the functions of the IOT medication device described herein. For example, the processor 202 may retrieve the data in the NFC tags 112 from medication containers 110 placed upon the NFC transceivers 108, parse the information from the NFC tag data, retrieve any associated or related information over an external communication network(s) 210, and update the clock display 106 and medication displays 114 accordingly, as described herein. The processor 202 may further write information to the NFC tags 112 of the containers through the NFC transceivers 108, such as compliance data, history of medication taken, and the like. The processor 202 may comprise a general-purpose processor, a PLC, an FPGA, or other processing component known in the art.

The controller 104 may further include a computer-readable storage medium or “memory” 204 for storing processor-executable instructions, data structures and other information used by the processor 202. The memory 204 may comprise a non-volatile memory, such as read-only memory (“ROM”) and/or FLASH memory, and a random-access memory (“RAM”), such as dynamic random access memory (“DRAM”) or synchronous dynamic random access memory (“SDRAM”). For example, the memory 204 may store a medication module 206 that comprises processor-executable instructions and data necessary for performing the operations of the IOT medication device 102 as described herein.

In addition to the memory 204, the IOT medication device 102 may include other computer-readable media storing program modules, data structures and other data described herein for managing patients' medication usage, compliance, and regimens. It will be appreciated by those skilled in the art that computer-readable media can be any available media that may be accessed by the controller 104 or any other application server(s) or computing systems described herein, including computer-readable storage media and communications media. Communications media includes transitory signals. Computer-readable storage media includes volatile and non-volatile, removable and non-removable storage media implemented in any method or technology for the non-transitory storage of information. For example, computer-readable storage media includes, but is not limited to, RAM, ROM, EPROM, EEPROM, FLASH memory or other solid-state memory technology, CD-ROM, DVD, BLU-RAY or other optical storage, magnetic cassettes, magnetic tape, magnetic disk storage or other magnetic storage devices and the like.

The controller 104 further includes a communication module 208. The communication module 208 may comprise one or more radios for establishing wireless communication links with the service and/or intermediate communication devices over one or more networks 210, as described below in regard to FIG. 3. The network(s) 210 may comprise any combination of personal area networks (“PANs”), local-area network networks (“LANs”), wide-area networks (“WANs”), cellular data networks, the Internet, and the like. The communication module 204 may implement any combination of a Wi-Fi radio or any of its variants (e.g. Wi-Fi direct), a Bluetooth or Bluetooth low-energy (“LE”) radio, and the like.

In further embodiments, the communication module 204 may utilize a proprietary, low-power connection technology or protocol that allows the IOT medication device 102 to communicate with an IOT router in the home or other space where the device is located. The IOT router may facilitate communication of the IOT medication device 102 with other network(s) 210, such as the Internet. The communication module 208 may further implement a cellular modem, allowing the IOT medication device 102 to be portable. According to some embodiments, the controller 104 may implement additional functionality, such as functionality to traverse firewalls and create a link to the cloud-based service across multiple, disparate networks 210; the ability to intermittently wake up and identify the IOT medication device 102 to the service; validate patient/user preferences for the device; schedule delivery of information; and the like. In further embodiments, the controller 104 may implement the functionality to access information associated with medication containers 110 or the medication contained therein directly from various, external data sources 316 (described below in regard to FIG. 3) across the network(s) 210 without the need of an intervening service, such as the IOT service 302 described below.

The controller 104 further includes a display controller 212 that allows the processor 202 to interface with and control the clock display 106 and the medications displays 114. The controller may further include an audio speaker (not shown) the IOT medication device 102. The speaker may allow the controller 104 to play audio media related to alarms related to the clock functionality, alerts, reminders, dosage information, and other aspects of the medication(s) contained in the medication containers 110 placed on the NFC transceivers 114, and the like. The IOT medication device 102 further includes an I/O controller for interfacing with the NFC transceivers 108, including any integrated scales or pill dispensers, in order to read and write data to the NFC tags 112 in the medication containers 110. It will be appreciated that the IOT medication device 102 and/or controller 104 may not include all of the components shown in FIG. 2, may include other components that are not explicitly shown in FIG. 2, or may utilize an architecture completely different than that shown in FIG. 2.

FIG. 3 shows an example operating environment 300 in accordance with the embodiments described herein. The environment 100 includes the IOT medication device 102 with the controller 104 described above in regard to FIGS. 1 and 2. According to some embodiments, the IOT medication device 102 receives information related to the medication in the NFC-tagged medication containers 110 from an IOT service 302. The IOT service 302 may comprise application software executing on one or more application servers 304, for example.

The IOT service 302 may receive or collect information associated with NFC-tagged medication containers 110 from various data sources and store the data in a database 306. For example, the IOT service may receive or collect an identifier of the medication contained in a specific medication container 110, an identifier of a patient for the medication, a prescription related with the medication container, a quantity of medication contained therein, dosing and timing information for the medication/patient according to the related prescription, an image of the medication with identifying codes and markings, compliance information, a record of medication taken, and/or the like. The data associated with the NFC-tagged medication container 110 may be provided from the pharmacy system(s) 310 filling the prescription and tagging the medication container and/or retrieved from various external data source(s) 316 over the network(s) 210, such as drug identification databases, patient information databases, prescriber information databases, and the like. The data associated with the NFC-tagged medication container 110 may be stored in the database 306 and related to an identifier of the specific medication container 110 contained in the NFC tag 112.

The IOT medication device 102 may request the data associated with a specific NFC-tagged medication container 110 from the IOT service 302 over the network(s) 210. For example, when a medication container 110 is placed upon an NFC transceiver 108, the controller 104 may read an identifier of the medication container from the NFC tag 112 through the transceiver. The controller 104 may then send the identifier of the medication container 110 to the IOT service 302 via the network(s) 210. The IOT service retrieves the data related to the identifier from the database 306 and returns it to the controller 104 over the network(s) 210. The controller 104 may further send data associated with the medication container 110 to the IOT service 302 along with the identifier of the container, such as compliance data, history of medication taken, and the like. The IOT service 302 may store this data in the database 306 related to the identifier of the medication container 110.

The IOT service 302 may provide an API 308 that allows the IOT medication device 102 to access the IOT service 302 over the network(s) 210 to retrieve or update the data associated with an NFC-tagged medication container 110. The API 308 may allow secure communications based on known authentication protocols and use encrypted messages to pass the data back and forth between the IOT medication device 102 and the IOT service 302. The API 308 may further facilitate access to the IOT service 302 and the data associated with the NFC-tagged medication container 110 to other computing devices of the patient 312, such as a user device 314 running a medication-related app or software program. The user device 314 may represent a smartphone, PDA, laptop computer, web server, or other computing device utilized by the patient 312.

The patient 312 may utilize the user device 314 to view or update information associated with medication containers 110 for currently active prescriptions, such as viewing or updating dosage or compliance information, noting side effects or efficacy, and the like. Similarly, the API 308 may further facilitate access to the IOT service 302 and the data associated with NFC-tagged medication containers 110 to computing devices of the authorized physicians or pharmacists, to view compliance information, check polypharmacy considerations, review patient-noted efficacy or side effect information, and the like.

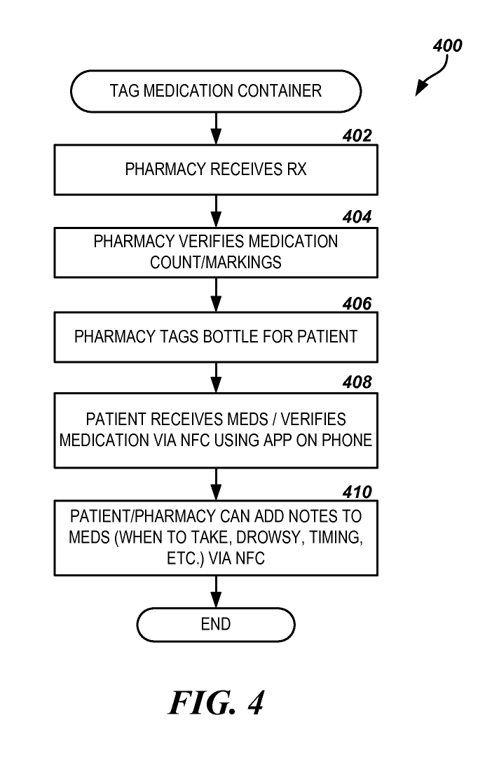

Referring now to FIG. 4, additional details will be provided regarding the embodiments presented herein. It should be appreciated that the logical operations or steps described with respect to FIG. 4 are implemented (1) as a sequence of computer implemented acts or program modules running on a processor, PLC, or other computing device and/or (2) as interconnected machine logic circuits or circuit modules within the various components and modules described herein. The implementation is a matter of choice dependent on the components selected in the implementation of the IOT medication device 102, the application server(s) 108, or the user device 314, as well as the performance and other requirements of the system. The logical operations described herein may be implemented in software or firmware of a device or computer system, in software or firmware within a microcontroller, in special purpose digital logic circuits, or any combination thereof. It should also be appreciated that more or fewer operations may be performed than shown in the figures and described herein. The operations may also be performed in a different order than described.

FIG. 4 illustrates a routine 400 for tagging a medication container 110 with information associated with a prescription/medication to be placed and distributed in the container. The routine 400 may be executed in part by the pharmacy systems 310 of the fulfilling pharmacy in cooperation with the IOT service 302 described above in regard to FIG. 3. The routine 400 begins at operation 402, where a pharmacy receives the prescription to be filled for a patient 312. The prescription may be received at the pharmacy systems 310 in digital form from the prescribing physician (direct to patient's preferred pharmacy), or in paper form from the patient entered by the pharmacy or agent, for example. The pharmacist verifies the prescription and the medication to be dispensed by count and markings (404) and then selects a medication container 110 for the medication. As described above, the medication container 110 may contain an embedded NFC tag 112 or an NFC tag may be applied to or inserted in the container by the pharmacist.

Next at operation 406, the pharmacist tags the medication container 110 with data associated with the prescription and/or medication. The pharmacist may use the pharmacy systems 310 and a local NFC transceiver to tag the medication container 110, for example. Tagging may comprise the pharmacy systems 310 writing the data associated with the medication container 110 to the NFC tag 112, including an identifier of the specific medication container, an identifier of the medication contained in the container, a quantity of medication contained therein, an identification of the patient, dosing and timing information for the medication/patient according to the related prescription, an image of the medication with identifying markings, and/or the like. In some embodiments, tagging may comprise the pharmacy systems 310 reading a unique identifier of from the NFC tag 112 of the medication container 110 and sending the identifier along with the data associated with the medication container to the IOT service 302 for storage in the database 306. Any combination of storing data associated with the medication container 110 to the NFC tag 112 and/or sending the data to the IOT service 302 may be imagined, and it is intended that all such combinations are included in this application. Upon receiving data from the pharmacy system 310 regarding a specific medication container 110, the IOT service 302 may retrieve additional information related to the medication container, the medication contained therein, and/or the related prescription for the external data sources 316 for storage in the database 306 related to the identifier of the medication container.

From operation 406, the routine 400 proceeds to operation 408, where the patient 312 receives the medication container 110 containing the medication. The patient 312 may then verify the medication therein. For example, the patient 312 may us an app on the user device 314 to verify the medication in the medication container 110 via NFC directly to the NFC tag 112 and/or by communication with the IOT service 302 described above. The patient/pharmacy may further use the app to add notes to the medication container 110, such as when to take the medication, possible side effects (drowsy), interactions with other medications, etc. The notes may be added by the app on the user device 314 or the pharmacy systems 316 directly to the NFC tag 112 of the medication container 110 and/or sent to the IOT service 302 to be stored in the database 306 related to the identifier of the medication container.

Based on the foregoing, it should be appreciated that technologies for managing patients' medication usage, compliance, and regimens are provided herein. The subject matter described above is provided by way of illustration only and should not be construed as limiting. Various modifications and changes may be made to the subject matter described herein without following the example embodiments and applications illustrated and described, and without departing from the true spirit and scope of the present invention.

What is claimed is:

1. An apparatus comprising:
a controller;
at least one near-field communication (“NFC”) transceiver operably connected to the controller and configured to read data from an NFC tag attached to a medication container placed in proximity to the at least one NFC transceiver; and
one or more displays operably connected to the controller and configured to display information related to a medication contained in the medication container.

2. The apparatus of claim 1, wherein the one or more displays comprise a clock display configured to display a time and alerts associated with taking the medication based on the data read from the NFC tag.

3. The apparatus of claim 1, wherein the one or more displays comprise a medication display associated with the at least one NFC transceiver and configured to display an image of the medication including identifying markings.

4. The apparatus of claim 3, wherein the medication display is further configured to display alert and dosing information associated with the medication.

5. The apparatus of claim 1, wherein the data read from the NFC tag comprises an identifier of the medication container, and wherein the controller is configured to retrieve one or more of an identifier of the medication, an identifier of a patient associated with the medication, an identifier of a prescribing doctor, a quantity of medication contained within the medication container, dosing and timing information associated with the medication, an image of the medication, and a record of medication taken from the medication container from a cloud service based on the identifier of the medication container.

6. The apparatus of claim 1, wherein the data read from the NFC tag comprises one or more of an identifier of the medication, an identifier of a patient associated with the medication, an identifier of a prescribing doctor, a quantity of medication contained within the medication container, dosing and timing information associated with the medication, an image of the medication, and a record of medication taken from the medication container.

7. The apparatus of claim 1, wherein the at least one NFC transceiver further comprises a compliance mechanism.

8. The apparatus of claim 7, wherein the compliance mechanism comprises a scale configured to record a weight of the medication container and information regarding a weight of each dose of the medication based on the data read from the NFC tag.

9. The apparatus of claim 1, wherein the at least one NFC transceiver is further configured to write a history of the medication taken to the NFC tag.

10. The apparatus of claim 1, wherein the controller comprises:
a processor operably connected to the at least one NFC transceiver and the one or more displays;
a communication module operably connected to the processor; and
a memory operably connected to the processor and containing a medication module configured to cause the processor to
read the data from the NFC tag when the medication container is placed in proximity to the at least one NFC transceiver,
retrieve the information related to the medication from a cloud service via the communication module based on the data red from the NFC tag, and
display at least a part of the retrieved information to the one or more displays.
read the data from the NFC tag when the medication container is placed in proximity to the at least one NFC transceiver,
retrieve the information related to the medication from a cloud service via the communication module based on the data red from the NFC tag, and
display at least a part of the retrieved information to the one or more displays.

11. A system comprising:
a database containing an identifier of a medication container and information regarding a medication prescription associated with the medication container;
a cloud service operably connected to the database and exposing an API to the Internet; and
an IOT medication device connected to the Internet and comprising at least one NFC transceiver and one or more displays, the IOT medication device configured to
read data from an NFC tag attached to the medication container when the medication container is placed in proximity to the at least one NFC transceiver,
retrieve the information regarding the medication prescription from the cloud service through the API based on the data read from the NFC tag, and
display at least a part of the information to the one or more displays.

12. The system of claim 11, wherein the information regarding the medication prescription comprises one or more of an identifier of a medication associated with the medication prescription, an identifier of a patient associated with the medication prescription, an identifier of a prescribing doctor associated with the medication prescription, a quantity of the medication contained within the medication container, and a record of medication taken from the medication container.

13. The system of claim 11, wherein the information regarding the medication prescription comprises an image of a medication associated with the medication prescription including identifying markings, and wherein the IOT medication device is further configured to display the image of the medication on one of the one or more displays.

14. The system of claim 11, wherein the information regarding the medication prescription comprises dosing and timing information associated with the medication prescription, and wherein the IOT medication device is further configured to display an alert and the dosing and timing information on one of the one or more displays.

15. The system of claim 11, wherein the IOT medication device is further configured to update the information regarding the medication prescription in the database through the API based on one or more of compliance data and history of the medication taken.

16. The system of claim 11, further comprising an app executing on a user device and configured to access and maintain the information regarding the medication prescription in the database through the API.

17. A method comprising steps of:
receiving, at a cloud service, a unique identifier of an NFC tag embedded in a medication container and data associated with the medication container;
storing the data in a database associated with the unique identifier;
receiving, at the cloud service, a request for the data associated with the medication container, the request containing the unique identifier; and
retrieving the data associated with the medication container based on the unique identifier and responding to the request with the data.

18. The method of claim 17, further comprising:
reading, by an IOT medication device, the unique identifier from the NFC tag when the medication container is placed in proximity to at least one NFC transceiver of the IOT medication device;
sending, by the IOT medication device, the request to the cloud service with the unique identifier;
receiving, from the cloud service, the data associated with the medication container; and
displaying, by the IOT medication device, at least a part of the data associated with the medication container on or one or more displays of the IOT medication device.

19. The method of claim 17, wherein the request is received from an app running on a user device of a patient associated with the medication container.

20. The method of claim 17, further comprising:
retrieving, from external data sources, additional information regarding a medication contained in the medication container based on an identifier of the medication included in the data associated with the medication container, wherein the external data sources comprise one or more of drug identification databases, patient information databases, and prescriber information databases.
